(19) United States
(12) Patent Application Publication
(10) Pub. No.: US 2024/0273416 A1
(43) Pub. Date: Aug. 15, 2024

(54) METHODS AND APPARATUS FOR ADDRESSING INTENTS USING MACHINE LEARNING

(71) Applicant: Telefonaktiebolaget LM Ericsson (publ), Stockholm (SE)

(72) Inventors: Jaeseong JEONG, Solna (SE); Alexandros NIKOU, Stockholm (SE); Ezeddin AL HAKIM, London (GB); Anusha Pradeep MUJUMDAR, Bangalore (IN); Marin ORLIC, Bromma (SE)

(21) Appl. No.: 18/569,632

(22) PCT Filed: Jun. 18, 2021
(86) PCT No.: PCT/EP2021/066716

§ 371 Date: Dec. 13, 2023

(51) Int. Cl. G06N 20/00

(52) U.S. Cl. CPC G06N 20/00

(57) ABSTRACT

Methods and apparatus for addressing intents using machine learning (ML) are provided. A method of operation for a node implementing ML, wherein the node instructs actions in an environment in accordance with a policy generated by a ML agent, and wherein the ML agent models the environment, includes obtaining an intent, wherein the intent specifies one or more criteria to be satisfied by the environment. The method further includes determining an intent cluster from among a plurality of intent clusters to which the intent maps, the determination being based on the criteria specified by the intent, and setting initialisation parameters for a ML model to be used to model the intent, based on the determined intent cluster. The method also includes training the ML model using training data specific to the intent, and generating one or more suggested actions to be performed on the environment using the trained ML model.

### TECHNICAL FIELD

Embodiments described herein relate to methods and apparatus for implementing Machine Learning (ML), in particular for implementing ML to generate suggested actions to be performed on an environment based on an intent.

### BACKGROUND

Management of complex systems, such as telecommunications networks, vehicular traffic management systems, and so on, is an ever-increasing challenge. In order to meet this challenge machine learning (ML) techniques such as reinforcement learning (RL) that enable effectiveness and adaptiveness may be implemented.

RL allows a Machine Learning System (MLS) to learn by attempting to maximise an expected cumulative reward for a series of actions utilising trial-and-error. RL agents (that is, a system which uses RL in order to improve performance in a given task over time) are typically closely linked to the system (environment) they are being used to model/control, and learn through experiences of performing actions that alter the state of the environment.

FIG. 1A illustrates schematically a typical RL system. In the architecture shown in FIG. 1, an agent receives data from, and transmits actions to, the environment which it is being used to model/control. For a time t, the agent receives information on a current state of the environment Sₜ. The agent then processes the information Sₜ, and generates one or more actions to be taken; one of these actions is to be implemented Aₜ. The action to be implemented is then transmitted back to the environment and put into effect. The result of the action is a change in the state of the environment with time, so at time t+1 the state of environment is Sₜ₊₁. The action also results in a (numerical, typically scalar) reward Rₜ₊₁, which is a measure of effect of the action Aₜ resulting in environment state Sₜ₊₁. The changed state of the environment Sₜ₊₁ is then transmitted from the environment to the agent, along with the reward Rₜ₊₁. FIG. 1 shows reward Rₜ being sent to the agent together with state Sₜ; reward Rₜ is the reward resulting from action Aₜ₋₁, performed on state Sₜ₋₁. When the agent receives state information Sₜ₊₁ this information is then processed in conjunction with reward Rₜ₊₁ in order to determine the next action Aₜ₊₁, and so on. The action to be implemented is selected by the agent from actions available to the agent with the aim of maximising the cumulative reward.

RL can provide a powerful solution for dealing with the problem of optimal decision making for agents interacting with uncertain environments. RL typically performs well when deriving optimal policies for optimising a given criterion encoded via a reward function. However, this strength of RL can also be a limitation in some circumstances. A given RL agent, once trained, cannot be directly utilized to effectively optimise for a criterion that is different from the criterion used in training the given RL agent.

Intent-driven cognitive architectures such as cognitive layers (CL), can be used to reflect more complex requirements. An intent is a formal specification of all expectations, including requirements, goals and constraints given to a technical system. Intents are often dynamic, that is, vary with time based on changing user requirements. An example of a generic intent would be, for arbitrary criteria X and Y and arbitrary numerical values A and B, “the value of X must remain below A and the value of Y must remain above B”. More definite examples, in the context of telecommunications networks, are: “the value of the signal to interference plus noise ratio (SINR) must remain below 0.2 and the network coverage must remain above 90%”, and “if the value of the SINR goes below 6, the network coverage must remain above 80% for the next 2 time steps”. The intent may therefore specify criteria to be satisfied. The above examples are comparatively simple; those skilled in the art will be aware that more complex intents may be used in some systems.

An example of an intent-driven architecture, specifically a CL, is shown in FIG. 1B. The CL serves as an interface between business operations and an environment. In the example shown in FIG. 1B, the environment is a telecommunications network comprising radio, core, Internet of Things (IoT), Business Support System (BSS) and Customer Experience Management (CEM) components. Objectives in a general form, such as “increase Quality of Experience (QoE)”, may be provided to the CL, which may then determine specific actions to be performed in the environment in order to meet the objectives. The CL consists of a knowledge base, a reasoning engine and an agent architecture, and also has access to data from the environment. The knowledge base contains an ontology of intents along with domain-specific knowledge such as the current state of the system; the knowledge base therefore provides descriptions of objects in the environment and relations between the objects. The domain-independent reasoning engine uses the knowledge base and serves as the central coordinator function for finding actions, evaluating their impact and ordering their execution. Finally, the agent architecture (comprising a number of ML agents and potentially other components used for data conversion, root cause analysis and so on) allows a number of models and services to be used. In operation, the reasoning engine may reformulate an objective received from business operations into an intent (using the knowledge base), obtain suggested actions from one or more agents from the agent architecture, then select an action to be implemented in the environment.

A CL may form part of an environment; using the example of a telecommunications network, a CL may form part of a network node, such as a core network node (CNN). Alternatively, a CL may be used in the control of an environment, but may not itself form part of the environment. An existing procedure for determining an action to perform using a CL based architecture is as follows. A CL receives an objective from a network operator, formulates an intent (for example, generates a logical specification from the received objective) and generates one or more criteria to be satisfied based on the intent, current environment status, and its prediction for the future environment status. The criteria are then delivered to proposers (which are responsible for proposing an action to be performed on the environment; an example of a proposer is a ML agent) that are bound to different parts of the environment. Using the example of a telecommunications network, different proposers may be responsible for controlling radio site parameters, core network parameters, and so on. Where the proposers are ML agents, each of these ML agents may host several ML models trained based on a specific purpose (such as, optimizing power, optimizing tilt, and so on). When a proposer receives criteria from a CL, it proposes an action using an equipped ML model (a power optimizer, tilt optimizer, and so on) to satisfy the criteria. An action is then selected from the proposed actions, by the CL or another component such as a network controller, and implemented in the environment.

In order to allow a proposer to propose a suitable action to satisfy one or more criteria, the proposer requires a suitable ML model, that is, a ML model that is optimised for the given criteria. The suitable ML model may be available to the proposer because the proposer maintains multiple ML models optimised for different criteria (using the example wherein the environment is all or part of a telecommunications network, different ML models may be optimised for a single Key Performance Indicator, KPI, or fixed combination of KPIs). Alternatively, the proposer may maintain a single ML model in an untrained state, and may then train the ML model from the untrained state based on the received criteria. Both of these options have drawbacks; maintaining multiple ML models optimised for all possible combinations of criteria is not realistic for environments (such as telecommunications networks) where the number of combinations of potential criteria is large, and training a ML model from an untrained state when criteria are received imposes a substantial processing burden and corresponding delay in providing suggested actions.

### SUMMARY

It is an object of the present disclosure to provide methods, apparatus and computer-readable media which at least partially address one or more of the challenges discussed above. In particular, it is an object of the present disclosure to facilitate the implementation of ML to allow the satisfaction of intents.

The present disclosure provides methods and apparatus for implementing ML, in particular for implementing ML to allow the satisfaction of intents with increased speed or efficiency of processing resource use relative to some existing methods and apparatus.

An embodiment provides a method of operation for a node implementing ML wherein the node instructs actions in an environment in accordance with a policy generated by a ML agent, and wherein the ML agent models the environment. The method comprises obtaining an intent, wherein the intent specifies one or more criteria to be satisfied by the environment, and determining an intent cluster from among a plurality of intent clusters to which the intent maps, the determination being based on the criteria specified by the intent. The method further comprises setting initialisation parameters for a ML model to be used to model the intent, based on the determined intent cluster, and training the ML model using training data specific to the intent. The method also comprises generating one or more suggested actions to be performed on the environment using the trained ML model. By mapping the intent to an intent cluster, and then setting initialisation parameters based on the determined intent cluster, embodiments allow the training of the ML model to be accomplished faster and using fewer processing resources, thereby providing increased efficiency.

The training data specific to the intent may be obtained using state transition information obtained from the environment. In particular, the state transition information may be converted into training data specific to the intent, the conversion comprising determining an intent specific reward for each state transition in the state transition information, the resulting training data specific to the intent being intent specific state transition information. In this way, general state transition information may be converted into training data specific to the intent, supporting rapid and effective training of the ML model. The training data may be particularly well suited where RL is used to train the ML model.

The step of determining the intent cluster to which the intent maps may comprise determining the similarity of the one or more criteria of the intent to the criteria of the intents in the plurality of intent clusters, in particular, the intent may be mapped to the intent cluster having the most similar criteria to those of the intent. Mapping the intent in this way may assist in the selection of effective initialisation parameters for the ML model. The mapping of the intent to an intent cluster may also be enhanced through the use of an ontological analysis of the intent criteria to determine related criteria to the one or more intent criteria, wherein the related criteria information is utilised when mapping the intent to an intent cluster. In this way the intent may be effectively mapped even where an exact criteria match to the criteria of an intent cluster may not be available.

For each intent cluster initialisation parameters may be determined. In particular, initialisation parameters may be determined using multi-task meta learning pre-training. Multi-task meta learning pre-training may provide an efficient means for obtaining initialisation parameters for an intent cluster.

The environment may be a telecommunications network, in particular, may be or comprise a wireless communications network. Embodiments may be particularly well suited to use in telecommunication network environments due to the potential range of intents, actions that may be taken, and so on.

A further embodiment provides node for implementing ML, wherein the node is configured to instruct actions in an environment in accordance with a policy generated by a ML agent that models the environment, wherein the node comprises processing circuitry and a memory containing instructions executable by the processing circuitry. The node is operable to obtain an intent, wherein the intent specifies one or more criteria to be satisfied by the environment, and to determine an intent cluster from among a plurality of intent clusters to which the intent maps, the determination being based on the criteria specified by the intent. The node is further configured to set initialisation parameters for a ML model to be used to model the intent, based on the determined intent cluster, and train the ML model using training data specific to the intent. The node is also configured to generate one or more suggested actions to be performed on the environment using the trained ML model. The node may provide one or more of the advantages discussed above in the context of the method.

### BRIEF DESCRIPTION OF DRAWINGS

The present disclosure is described, by way of example only, with reference to the following figures, in which:—

FIG. 1A is a schematic diagram of a RL system;

FIG. 1B is a diagram of an example of an intent-driven architecture;

FIG. 2 is a flowchart of a method performed by a node in accordance with embodiments;

FIGS. 3A and 3B are schematic diagrams of nodes in accordance with embodiments;

FIG. 4 is a diagram of an example criteria space showing three clusters of intents according to an embodiment;

FIG. 5 is a portion of a knowledge graph relating to telecommunications systems in accordance with an embodiment; and

FIG. 6 is an illustration of the process by which MTML may be used to increase the efficiency with which a ML model may be trained in accordance with an embodiment.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

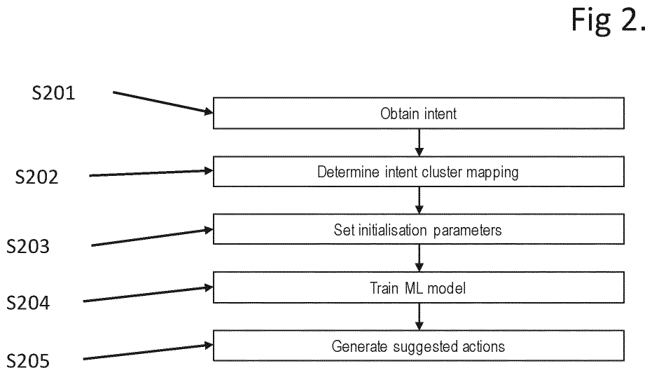

A method in accordance with embodiments is illustrated by FIG. 2, which is a flowchart showing an operation method of a node for implementing ML, wherein the node instructs actions in an environment in accordance with a policy generated by a ML agent, and wherein the ML agent models the environment. The nature of the node, actions, environment and policy are dependent on the specific system in which the method is used; taking the example where the environment is a telecommunications network (or part of the same), the node may be a base station or core network node (or may be incorporated in a base station or core network node), and the ML model (generated by the ML agent based on the environment modelling) may cause the node to suggest actions such as rerouting traffic in the telecommunications network, increasing network capacity, altering transmission parameters, altering antenna pitch and so on. As a further example, the environment may be a traffic management system (or part of the same), the client may be the controller for one or more traffic lights, and the ML model may suggest alterations to the lighting sequence used for the lights to reduce congestion.

The method shown in FIG. 2 may utilise multi-task meta learning (MTML). MTML is a method for training a ML model to enable fast adaptation to a variety of learning tasks, such that the model can solve a new learning task with a small number of samples and gradient iterations. A discussion of a model-agnostic form of meta learning can be found in “Model-agnostic meta-learning for fast adaptation of deep networks” by Finn, C., Abbeel, P. and Levine, S, available at https://arxiv.org/pdf/1703.03400.pdf as of 26 May 2021. The discussion includes an algorithm used to train a model with gradient descent for a variety of different learning problems, including classification, regression, and reinforcement learning. MTML essentially allows ML model parameters to be pre-trained from arbitrary starting values to values close to being suitable for all of the multiple tasks; these pre-trained parameters can then be used as the starting point for specific training of a ML model to be suitable for one of the tasks. Using MTML allows the training of a ML model to be shortened, such that a model can be sufficiently trained for use in a smaller number of rounds of training (that is, in fewer epochs) than may be realistic without the use of MTML. As an alternative to the use of MTML, the method shown in FIG. 2 may utilise alternative means for shortening the training of ML models, such as transfer learning.

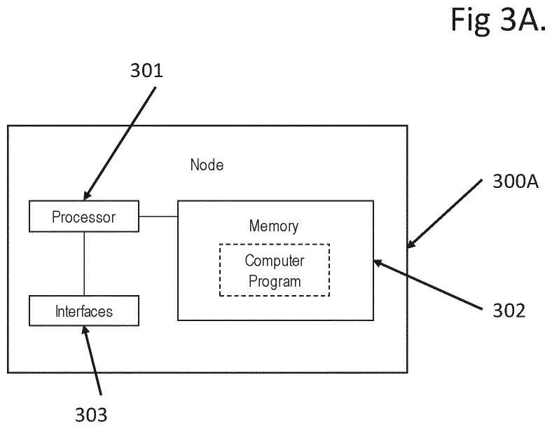

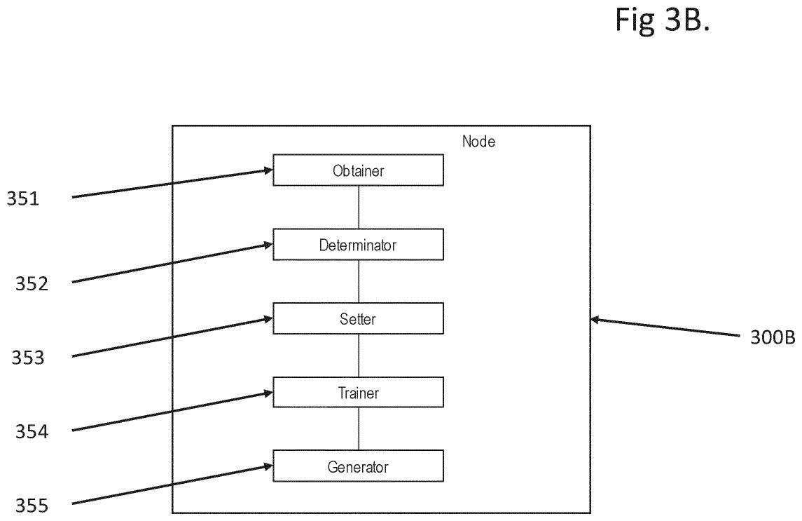

The method shown in FIG. 2 is performed by a node. Any suitable node may be used; FIG. 3A and FIG. 3B show nodes 300A, 300B in accordance with embodiments. The nodes 300A, 300B may perform the method of FIG. 2. In some embodiments, the environment may be all or part of a telecommunications network; where this is the case the node may be a node in the network, such as a base station or core network node. The telecommunications network may be a 3^{rd} Generation Partnership Project (3GPP) 4^{th} Generation (4G) or 5^{th} Generation (5G) network. The node may be or form part of a Core Network Node (CNN), or may be or form part of a base station (which may be 4th Generation, 4G, Evolved Node Bs, eNB, or 5th Generation, 5G, next Generation Node Bs, gNBs, for example). Further the features encoding a state may include base station configuration measurements, signal to interference plus noise ratios (SINR) and/or other key performance indicators, capacity measurements, coverage measurements, Quality of Service (QoS) measurements, and so on. Also, actions suggested by a ML agent may include antenna configuration adjustments (such as antenna positioning changes), transmission parameter adjustments; data traffic routing or rerouting alterations; and so on.

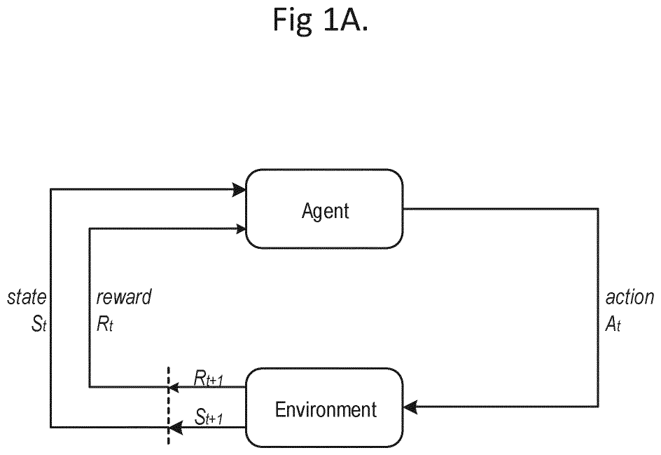

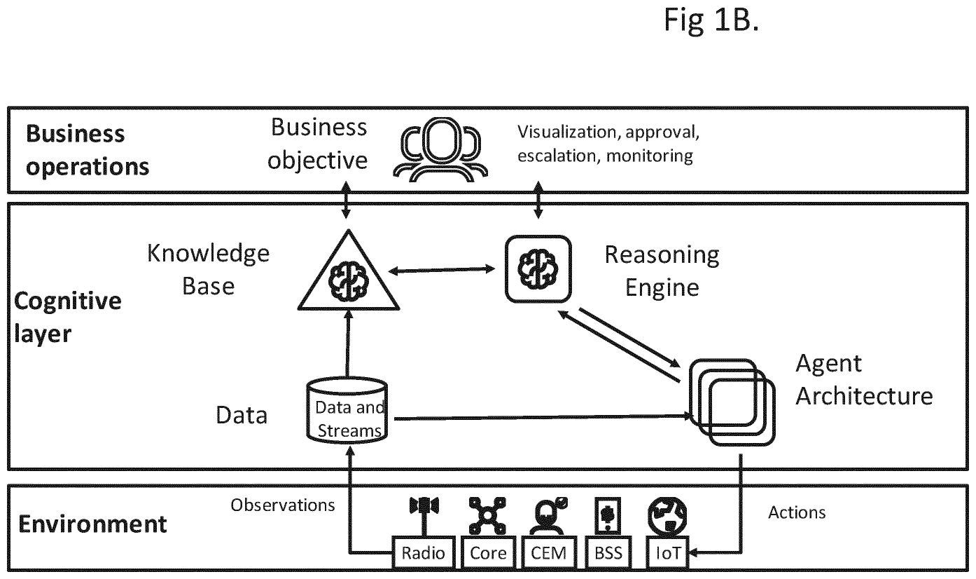

As shown in step S201 of FIG. 2 the method comprises obtaining an intent. The intent may be inputted into a node (for example, by a user), although typically the intents are obtained from a CL component such as a reasoning engine (see FIG. 1B), potentially having been initially provided as an objective. The intent may encompass one or more criteria to be satisfied by the environment; using the example of a telecommunications network the intent may include general criteria (such as maintaining SINR below a certain level), safety specifications (such as ensuring a minimum level of coverage and capacity), domain guidance for ML training (such as “Eventually, it is always the case that: Coverage, once high, does not go back to low AND Capacity, once high, does not go back to low), and so on.

The intent may be obtained by the node in the form of a natural language statement, or may be obtained as a logical specification using logical symbols. Where the intent is obtained as a natural language statement, it may be converted into a logical specification, for example, using an intent converter. An example of a natural language statement of an intent, in the context of a telecommunications network, is “SINR, network coverage and received signal quality are never degraded together”. A logical specification corresponding to the above natural language statement, using linear temporal logic symbols, would be □(¬(SINRLow∧covLow∧quaLow)), where □ is a logical “always” operator, ¬ is a logical “not” operator, ∧ is a logical “and” operator, SINRLow indicates a low average SINR, covLow indicates a low network coverage and quaLow indicates a low average received signal quality. In this example, the environment is all or part of a telecommunications network; the state of the environment would be encoded by a ML agent using a set of features representing the state of the network, such as the average SINR, network coverage, average received signal quality, total network capacity, and so on. The above example utilises linear temporal logic, however as will be appreciated by those skilled in the art other logical systems may also be utilised, including specialised languages devised specifically for this purpose; a choice of which logical system to use may be determined at least in part based on the configuration of a system implementing the method. The step of obtaining the intent may be performed in accordance with a computer program stored in a memory 302, executed by a processor 301 in conjunction with one or more interfaces 303, as illustrated by FIG. 3A. Alternatively, the step of obtaining the intent may be performed by an obtainer 351 as shown in FIG. 3B.

When the intent has been obtained, the method further comprises determining an intent cluster from among a plurality of intent clusters to which the intent maps, as shown in step S202. The step of determining the intent cluster to which the intent maps may be performed in accordance with a computer program stored in a memory 302, executed by a processor 301 in conjunction with one or more interfaces 303, as illustrated by FIG. 3A. Alternatively, the step of determining the intent cluster to which the intent maps may be performed by a determinator 352 as shown in FIG. 3B.

The intent clusters are groupings of existing intents (for which ML models may previously have been trained) in criteria space, typically wherein the intents are grouped based on similarity of criteria. The intents forming the plurality of intent clusters may be obtained, for example, from a database of previously obtained intents linked to trained ML models. The database may also comprise generic intents (and associated trained ML models), such as the increase of a known KPI. Additionally or alternatively, the intents forming the plurality of intent clusters may be obtained from online sources utilising CL systems.

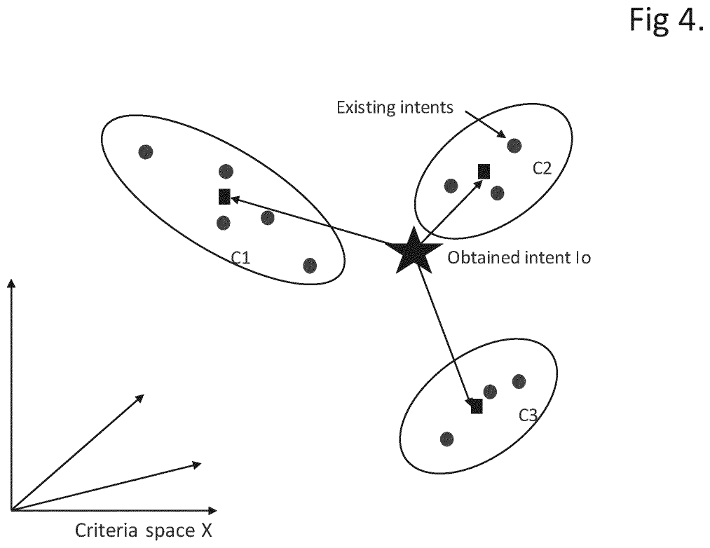

FIG. 4 is a diagram of an example criteria space showing three clusters of intents in accordance with an embodiment; the clusters are labelled C1, C2 and C3. The dimensions of the criteria space are determined by the criteria in the plurality of intents forming the plurality of intent clusters; using the example wherein the environment is a telecommunications network, the dimensions of the criteria space may include a coverage dimension, a Signal to Interference plus Noise Ratio (SINR) dimension, a capacity dimension, and so on. Other dimensions may be used based on further Key Performance Indicators (KPIs) as are commonly used in the evaluation of telecommunications networks. In the example shown in FIG. 4, the criteria space (X) has 4 dimensions, X=[X1,X2,X3,X4], corresponding to 4 different criteria. Each individual intent may not specify every criteria in the criteria space, the number of dimensions is determined by criteria from all of the intents. As an example of this, a first intent I1 may include criteria X1 and X2 (I1=[X1,X2]), a second intent I2 may include criteria X1 and X3 (I2=[X1,X3]), a third intent I3 may include criteria X2 and X4 (I3=[X2,X4]), and so on.

In embodiments, the intents in the clusters may be grouped using any suitable grouping technique, for example, using centroid clustering (such as K-means clustering), density clustering and so on.

K-means clustering is an example of centroid clustering. In K-means clustering, target number of clusters K is defined, and K therefore also defines the number of centroids in a given dataset. The centroids are the means, average points or “centers” of a given dataset, and are calculated by starting from an initial candidate set of centroids, and then optimizing them iteratively until the centroid locations become stable over iterations. Then, the data points are assigned to their nearest centroid (using a suitable distance measure such as a sum of squares) to form K groups or clusters.

Density-based clustering methods can discover clusters of arbitrary shapes without the number of clusters being specified by a human. Density-based clustering methods typically look for regions of the data that are denser than the surrounding space to form “core” data points, and also identify “border” data points that belong to a cluster with core data points, i.e. the border data points are density-reachable from the core data points. Density-based clustering methods typically also distinguish outliers, i.e. those data points that are neither core nor border points in any of the clusters, and hence are not assigned to any cluster.

One or more of the above techniques may be used to form the intent clusters, and may also be used when determining an intent cluster among the plurality of intent clusters to which the obtained intent maps. Determining an intent cluster among the plurality of intent clusters to which the intent maps typically comprises determining the similarity of the one or more criteria of the intent to the criteria of the intents in the plurality of intent cluster; the intent may then be mapped to the intent cluster having the most similar criteria to the criteria of the intent. The similarity between the criteria of the intent and the criteria of the plurality of intent clusters can be determined using any suitable similarity calculation technique, for example, using normalised distance measurements. Using the example of centroid clustering, in order to determine the intent cluster to which an obtained intent maps, the position of the obtained intent in criteria space is determined and the normalised distance to the centroids of each of the plurality of intent clusters from the position is then calculated. The obtained intent may then be determined to map, for example to the cluster having the closest centroid (shortest normalised distance) to the position. Returning to the example shown in FIG. 4, the centroids of the clusters C1, C2 and C3 are indicated by rectangles, with the individual intents in the clusters indicated by circles. The obtained intent lo is indicated by a star. The normalised distances between Io and the cluster centroids are indicated by arrows; the shortest of these distances is to the centroid of cluster C2, therefore it may be determined that C2 is the intent cluster having the most similar features to that of obtained intent Io, and Io may be mapped to cluster C2.

In embodiments a predetermined threshold may be used when determining a cluster to which an intent may be mapped; if the similarity of the one or more criteria of the obtained intent to the criteria of the intent cluster is less than the predetermined threshold value, the obtained intent is not mapped to this cluster. Where the similarity of the one or more criteria of the obtained intent to the criteria of the intent cluster is less than the predetermined threshold value for all of the plurality of intent clusters, the obtained intent may be mapped to a new intent cluster. The new intent cluster may initially comprise only the obtained intent, however upon initiation of a new cluster this cluster may be populated with further intents obtained from the database or online as discussed above.

A predetermined threshold may be used whenever the similarity between the obtained intent and the plurality of intent clusters is determined, but may be of particular use where the determination of the mapping of the obtained intent to an intent cluster takes into account further factors. An example of a further factor that may be used when determining mapping for an obtained intent is an ontological analysis of the intent criteria.

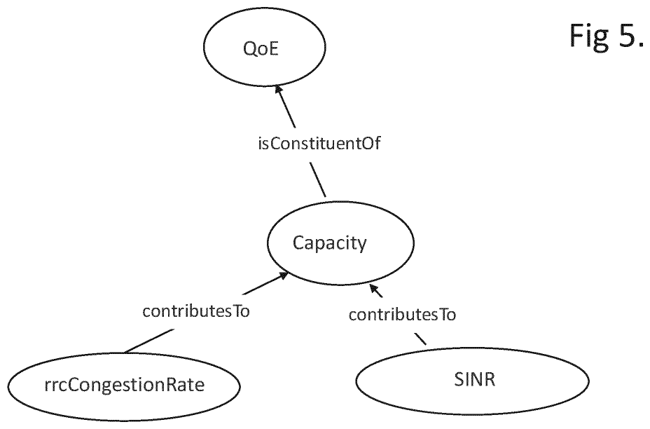

Ontological analysis of the intent criteria is a form of knowledge based clustering, which may be used to incorporate knowledge of interrelations between criteria (for example, knowledge contained in a CL knowledge base). FIG. 5 is a portion of a knowledge graph relating to telecommunications systems showing relationships between several KPIs. More specifically, FIG. 5 shows the relationships between SINR, Radio Resource Control Congestion Rate (rrcCongestionRate), capacity and user Quality of Experience (QoE). Using an ontological analysis of intent criteria may help in the determination of which of the plurality of intent clusters an obtained intent should be mapped to, based on criteria related to the intent criteria. For example, if an obtained intent has the criteria “maximize SINR AND rrcCongestionRate”, referring to the knowledge graph of the ontology in FIG. 5 reveals that these criteria are related to Capacity. The intent could therefore be mapped to the cluster which has intents including Capacity, or QoE. Use of ontological analysis in this way may be of particular value where the determination of which intent cluster an obtained intent should be mapped to is not clearly determined based on a similarity comparison of the criteria as discussed above. Ontological analysis may also be used when generating the plurality of intent clusters, for example, to identify related criteria to the criteria of each intent.

At step S203, initialisation parameters for a ML model to be used to model the intent are set, based on the determined intent cluster. As the intents within an intent cluster have similar criteria to be satisfied, the parameters for ML models that can be used to suggest actions to cause the environment to satisfy the criteria are also similar. For each intent cluster, initialisation parameters are determined; the parameters may be determined, for example, using MTML or transfer of parameters from existing ML models. The step of setting the initialisation parameters may be performed in accordance with a computer program stored in a memory 302, executed by a processor 301 in conjunction with one or more interfaces 303, as illustrated by FIG. 3A. Alternatively, the step of setting the initialisation parameters may be performed by a setter 353 as shown in FIG. 3B.

Where MTML is used, the initialisation parameters may be determined using the intents in the intent cluster and intent specific state transition information for the intents in the intent cluster. Given the criteria in an intent, an optimisation intent function based on current (Sₜ) and next (Sₜ₊₁) states of the environment may be generated. The optimisation intent function may be used to evaluate a potential action (A) to be performed on the environment; returning a positive value if the action would help achieve the intent and a negative value if it would not. Some examples of optimisation intent functions (using the environment of all or part of a telecommunications network) are as follows:

Given the intent of reducing latency, an optimization intent function G(⋅) may return a value of 1 if latency(Sₜ₊₁)<latency(S), else may return a value of 0. Several parameters contribute to the overall latency and it is not easily expressed analytically.

Given the intent of reducing energy consumption, an optimization intent function G(⋅) may return a value of 1 if energy(Sₜ₊₁)<energy(S), else may return a value of 0. Energy conservation is a broad intent and can be contributed to in many ways, the most desired approach is typically by a number of incremental improvements.

Given the intent of maximizing a weighted subset of KPIs, an optimization intent function G(⋅) may return a value of 1 if ΣKPIs(Sₜ₊₁)>ΣKPIs(S), else may return a value of 0. Maximising KPIs may be applicable to various cost functions in the environment (for example, processing cost is a weighted sum of consumed processing, memory and storage).

The MTML process may utilise one or more, potentially all, of the optimisation intent functions for intents in a cluster, in conjunction with a data set of state transition information obtained from the environment. The state transition information may comprise data on a plurality of state transitions, of the form <state, action, next state> (that is, <Sₜ, Aₜ, Sₜ₌₁>). The state transitions in the data set may be referred to as generic transitions, as the state transitions do not include any reward function information that may be generated as a result of the transition. The generic transitions may be converted into specific transitions that are specific to a particular intent by calculating the reward that would have resulted from the transition, wherein the reward may be calculated using the optimisation intent function for the particular intent. The converted transition would then be intent specific state transition information, of the form<Sₜ, Aₜ, Sₜ₌₁, Rₜ>, where Rₜ=G(Sₜ, Sₜ₊₁). Once one or more of the optimisation intent functions for intents in a cluster have been selected, state transitions in the data set may then be converted into intent specific state transition information, then this information may be used as training data in the MTML process to identify a set of ML model parameters that are a good fit for all of the selected one or more intents in the cluster; these are the initialisation parameters for the cluster.

Once the initialisation parameters for the ML model to be used to model the intent have been set, the ML model may then be trained using training data specific to the obtained intent, as shown in step S204. The step of training the ML model may be performed in accordance with a computer program stored in a memory 302, executed by a processor 301 in conjunction with one or more interfaces 303, as illustrated by FIG. 3A. Alternatively, the step of training the ML model may be performed by a trainer 354 as shown in FIG. 3B. The data used to train the ML model (starting from the initialisation parameters) may be obtained using the state transition information, in particular, may be obtained by converting generic transitions into specific transitions (including reward information) that are specific to the obtained intent as discussed above, thereby obtaining intent specific state transition information. Any suitable training method may be used to train the ML model, RL as discussed above is particularly well suited to this task where intent specific state transition information is to be used for training. Those skilled in the art will be aware of method by which ML models may be trained. Using this intent specific state transition information, the ML model may then be trained until the actions suggested using the model are of a sufficiently high standard (which may be judged by evaluating the rewards that would be obtained using the actions), at which point the ML model may be considered to be trained.

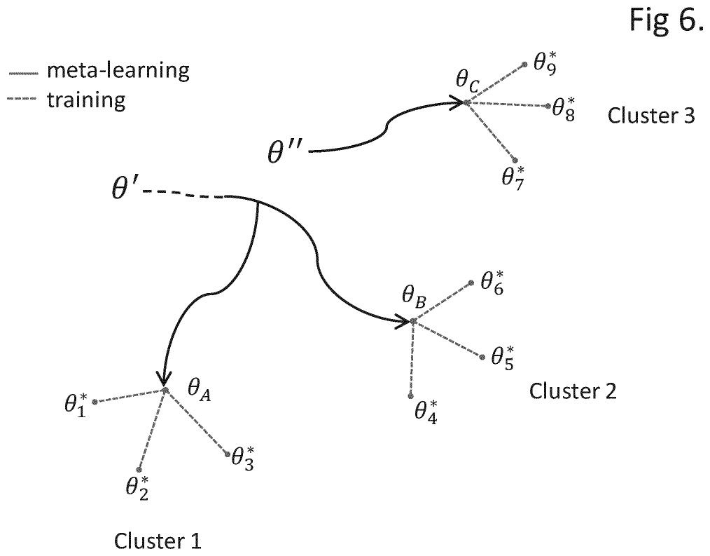

FIG. 6 is an illustration of the process by which MTML may be used to increase the efficiency with which a ML model may be trained. The figure shows changes in parameters during the pre-training and training process; the figure uses parameter space to illustrate the changes. Starting from arbitrary ML model parameters θ′ or θ″, MTML may be used in a pre-training process to obtain the cluster specific initialisation parameters θ_{A}, θ_{B} and θ_{C}, which are the initialisation parameters for clusters 1, 2 and 3 respectively as shown in FIG. 6. When an intent is subsequently determined to map to one of the clusters, the initialisation parameters for the determined cluster are then used as the starting point for the training of a ML model using training data specific to the intent. The trained models are indicated on FIG. 6 as θ*_{N}, where N=1 to 9. Trained models θ*₁ to θ*₃ were trained starting from initialisation parameters θ_{A}, trained models θ*₄ to θ*₆ were trained starting from initialisation parameters θ_{B}, and trained models θ*₇ to θ*₉ were trained starting from initialisation parameters θ_{C}.

As is illustrated by the figure, the amount of change required in the model parameters when starting from the cluster specific initialisation parameters is reduced relative to the arbitrary parameters. As the amount of variation in model parameters between the starting point for training and the final (trained) parameters is typically proportional to the number of rounds of training required, use of the initialisation parameters therefore equates to a reduction in the amount of training required to generate the trained ML model once an intent has been obtained.

Once the training process has been completed, the trained ML model may then be used to generate one or more suggested actions to be performed on the environment, as shown in step S205. The step of generating the suggested actions may be performed in accordance with a computer program stored in a memory 302, executed by a processor 301 in conjunction with one or more interfaces 303, as illustrated by FIG. 3A. Alternatively, the step of generating the suggested actions may be performed by a generator 355 as shown in FIG. 3B. Using the example wherein the environment is all or part of a telecommunications network, the suggested actions may comprise, for example, network node configuration adjustments and/or network link configuration adjustments. In particular, where the telecommunication network is or comprises a wireless communication network, the suggested actions may comprise one or more of: base station configuration adjustments; antenna configuration adjustments; wireless device configuration adjustments; transmission parameter adjustments; and data traffic routing or rerouting alterations. The method may further comprise selecting an action from among the one or more suggested actions, and causing the action to be implemented in the environment; this selection may be made by the node as shown in FIG. 3A or 3B (for example) or a further component such as a network controller.

Embodiments may be utilised, for example, to quickly and efficiently add ML models to a system when intents for which no specific ML models are present in the system are obtained, thereby allowing the system to adapt quickly to new intents. Further uses include adding new ML models to existing systems; these new models may identify new solutions not arrived at by existing ML models. A number of ML models may be generated, potentially combined with existing models, and then tested using a selection of intents such that the best performing ML models may be selected and retained. Embodiments may also help avoid the need to maintain a large number of specialised ML models. Embodiments may therefore help address intents using ML faster and/or using fewer processing resources than existing systems.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some embodiments may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/ or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A method of operation for a node implementing machine learning, ML, wherein the node instructs actions in an environment in accordance with a policy generated by a ML agent, and wherein the ML agent models the environment, the method comprising:
obtaining an intent, wherein the intent specifies one or more criteria to be satisfied by the environment;
determining an intent cluster from among a plurality of intent clusters to which the intent maps, the determination being based on the criteria specified by the intent;
setting initialisation parameters for a ML model to be used to model the intent, based on the determined intent cluster;
training the ML model using training data specific to the intent; and
generating one or more suggested actions to be performed on the environment using the trained ML model.

2.-20. (canceled)

21. A node for implementing machine learning, ML, wherein the node is configured to instruct actions in an environment in accordance with a policy generated by a ML agent that models the environment, wherein the node comprises processing circuitry and a memory containing instructions executable by the processing circuitry, whereby the node is operable to:
obtain an intent, wherein the intent specifies one or more criteria to be satisfied by the environment;
determine an intent cluster from among a plurality of intent clusters to which the intent maps, the determination being based on the criteria specified by the intent;
set initialisation parameters for a ML model to be used to model the intent, based on the determined intent cluster;
train the ML model using training data specific to the intent; and
generate one or more suggested actions to be performed on the environment using the trained ML model.

22. The node of claim 21, configured to obtain the training data specific to the intent using state transition information obtained from the environment.

23. The node of claim 22, configured to convert the state transition information into training data specific to the intent, the conversion comprising determining an intent specific reward for each state transition in the state transition information, the resulting training data specific to the intent being intent specific state transition information.

24. The node of claim 22, configured to use reinforcement learning, RL, to train the ML model

25. The node of claim 21, configured to determine the intent cluster to which the intent maps by determining the similarity of the one or more criteria of the intent to the criteria of the intents in the plurality of intent clusters.

26. The node of claim 25, wherein the intent is mapped to the intent cluster having the most similar criteria to those of the intent.

27. The node of claim 25, configured to determine the similarity of the one or more intent criteria to the criteria of each intent cluster among the plurality of intent clusters using normalised distance measurements.

28. The node of claim 27 configured such that, if the similarity of the one or more intent criteria to the criteria of a first intent cluster among the plurality of intent clusters is less than a predetermined threshold value, the intent is not mapped to the first intent cluster.

29. The node of claim 28 configured such that, if the similarity of the one or more intent criteria to the criteria of each of the intent clusters among the plurality of intent clusters is less than a predetermined threshold value, the intent is mapped to a new intent cluster.

30. The node of claim 25, configured to determine the intent cluster to which the intent maps by performing an ontological analysis of the intent criteria to determine related criteria to the one or more intent criteria, and utilising the related criteria information to map the intent to an intent cluster.

31. The node of claim 21 further configured to generate the plurality of intent clusters.

32. The node of claim 31, configured to generate the plurality of intent clusters in criteria space using K-means clustering or density clustering.

33. The node of claim 31, configured to generate the plurality of intent clusters by performing an ontological analysis of the intent criteria of each intent to determine related criteria to the intent criteria, and utilising the related criteria information when generating the plurality of intent clusters.

34. The node of claim 21 configured to determine, for each intent cluster, initialisation parameters.

35. The node of claim 34, configured to determine the initialisation parameters using multi-task meta learning pre-training.

36. The node of claim 35 configured to determine, using the multi-task meta learning pre-training, the initialisation parameters for each intent cluster using the intents in the intent cluster and intent specific state transition information for the intents in the intent cluster.

37. The node of claim 21 further configured to select an action from the one or more suggested actions, and to cause the action to be implemented in the environment.

38. The node of claim 37, wherein the environment is at least a part of a telecommunications network.

39. The node of claim 38, wherein the one or more suggested actions comprise one or more of: network node configuration adjustments; and network link configuration adjustments, wherein the telecommunication network is or comprises a wireless communication network, and wherein the one or more suggested actions comprise one or more of: base station configuration adjustments; antenna configuration adjustments; wireless device configuration adjustments; transmission parameter adjustments; and data traffic routing or rerouting alterations.

40. (canceled)

41.-42. (canceled)
